(19) United States
(12) Patent Application Publication
(10) Pub. No.: US 2024/0157914 A1
(43) Pub. Date: May 16, 2024

(54) VEHICLE WASHING SYSTEM AND METHOD

(71) Applicant: Smith Intellectual Property, LLC, Greencastle, IN (US)

(72) Inventors: Judson Smith, Greencastle, IN (US); Zachary Bradford Smith, Phoenix, AZ (US)

(73) Assignee: Smith Intellectual Property, LLC, Greencastle, IN (US)

(21) Appl. No.: 18/495,114

(22) Filed: Oct. 26, 2023

Related U.S. Application Data
(60) Provisional application No. 63/419,498, filed on Oct. 26, 2022.

(51) Int. Cl. B60S 3/06

(52) U.S. Cl. CPC B60S 3/063

(57) ABSTRACT

Washing devices, systems and methods comprise mitter systems suspended from a support. A first axle is mounted to the support and rotates about a first vertical axis. A pivot arm rotates with the first axle. A second axle is mounted to the pivot arm and is rotatable about a second vertical axis. A planetary gear system has a first gear secured in a horizontal plane to the support and located coaxial with the first axle. The planetary gear comprises a second gear mounted to the second axle and rotating about the second vertical axis. Rotation of the pivot arm causes the second axle and the second gear to be rotated. A frame is mounted to the second axle and a plurality of mitter strips extend downwardly therefrom.

### CROSS-REFERENCE TO RELATED APPLICATION

This application claims the benefit of U.S. Provisional Application No. 63/419,498 filed Oct. 26, 2022, which is hereby incorporated by reference.

### BACKGROUND OF THE INVENTION

This invention relates to devices, systems and methods relating to the washing of vehicles. The devices include mitter systems comprising elongated mitter strips which hang vertically and contain brushes which bear against a vehicle as it is washed. In particular embodiments, the brush carriers include apertures in which the brushes are received. Ancillary components may also be included. The systems and methods include the manipulation of the mitter systems to move them relative to a vehicle.

The art is well known relative to automatic vehicle washing. Such systems typically use rotating brushes and hang-down mitting curtains, which collectively have become the preferred industry standard equipment for automatically washing vehicles. The prior art discloses using a variety of cleaning materials for rotating brushes and hang-down mitting curtains, including polyethylene and polypropylene extruded strands, strips of synthetic felt, plastic fabric, and open and closed cell foam plastic.

It is apparent from the prior art that a continuing objective in new developments for bristle brush arrangements has been to achieve and maintain good cleaning action from the tip speed and contact of the bristle tip ends with the surface being cleaned. For example, orbital type movement of the bristle tips of a toothbrush has long recommended as part of dental hygiene guidance.

As shown in the art, this objective is easier to achieve with rotating brushes when they are used in cleaning flat or uniform type surfaces (e.g., street sweeping brushes) and can be rotated at relatively high speeds, e.g., 100-120 RPMs. However, it has always been difficult for automatic vehicle washing systems to use rotating bristle type brushes to properly and safely wash a vehicle. This is because vehicle shapes, sizes, and types of exterior painted surfaces and coatings represent extraordinary challenges for automatic vehicle washing equipment employing rotating brushes. It is important to achieve the proper tip speed and contact of rotating bristle brush tips. Also, the brushes must be gentle and soft, and be able to closely follow and penetrate the intricate contours of the various types of vehicles. If the rotating brushes do not operate in a precise manner, i.e., proper rotational speed and brush crush, vehicle damage can result, including: micro hazing and marring of the vehicle's exterior painted and coated surfaces; damage to antennae; and damage to mirrors. Also, the rotating cylinder housings which hold the brush strips are generally made of aluminum or stainless steel and are quite heavy once the wash media is attached. They are also costly to manufacture and maintain.

More recent prior art discloses means for rotating brushes using different bristle media consisting in part of felt, cotton and polyester woven fabric, foam, and closed cell foam. These types of materials can be rotated at much slower speeds, typically 60-100 RPMs, and can be configured to include multiple cleaning edges to help penetrate the recessed areas of vehicles. The prior art discloses very unique ways to incorporate differently configured washing media into a rotating brush, and also addresses the rotational requirements by achieving varying rotational RPM's of a brush.

Vehicle washes use single direction rotary type brushes that perform best when rotary brushes wash with the tips of the bristles. However, rotary type brushes frequently miss areas of the car's exterior surface, e.g., recessed windows, louvers, mirrors, moldings, etc., because their inherent single direction rotation and inconsistent “crush” pressure causes overlaps that do not allow for consistent bristle tip cleaning of the stated areas.

Additionally, the prior art relating to hang-down mitting curtains is also extensive. The art relates to both the mechanical movement of mitting curtains for improved agitating type washing actions, and the material and design configurations of the curtains to provide better vehicle washing of the irregularities of vehicle surfaces. There is further but limited prior art which discloses complex means for rotating, reciprocating and oscillating type vehicle washing brush media, vibrating brush media, and flexible brushes.

Although advancements in automatic vehicle washing equipment have been significant over the years, there still remain many problem areas that need improvement. These problem areas include vehicle damage caused by rotating brushes; overuse of water and chemicals by the rotating brushes flinging solution away from the vehicle due to the centrifugal action of the rotating brushes; excessive noise caused by the rotating brush actions and mitting curtains which cause a slapping effect against the vehicle; parts of the vehicle remaining uncleaned due to missing washing actions caused by rotating brushes rotating in only one direction and being unable to consistently clean with its bristle tips, frequently overlapping recessed parts of the vehicle's surfaces; excessive use of electrical power; complex multiple pieces of washing equipment being required; equipment wear, with replacement and repair being costly and time consuming; and original capital investment required for automatic vehicle washing equipment, buildings, and land.

This disclosure effectively addresses these problem areas with novel improvements that will be readily apparent through the reading and understanding of the following summary and description of the invention.

### SUMMARY OF THE INVENTION

The present invention is directed to a washing apparatus comprising a horizontal support and a first axle mounted to the horizontal support and rotatable about a first vertical axis. A pivot arm has a first end secured to the first axle to rotate with the first axle. A second axle is mounted to a second end of the pivot arm and is rotatable about a second vertical axis. A planetary gear system comprises a first gear fixedly secured in a horizontal plane to the horizontal support and located coaxial with the first axle. The planetary gear comprises a second gear smaller than the first gear, the second gear being fixedly mounted to the second axle. The second gear being rotatable about the second vertical axis. The first and second gears are engaged such that rotation of the pivot arm causes the second axle and the second gear to be rotated by the first gear. A frame is mounted to the second axle; and a plurality of mitter strips are attached to the frame and extend downwardly therefrom.

Further forms, objects, features, aspects, benefits, advantages, and embodiments of the present invention will become apparent from the detailed description and drawings provided herewith.

### BRIEF DESCRIPTION OF THE DRAWINGS

FIG. 1 is a perspective view of a washing apparatus in accordance with an exemplary embodiment of the present invention.

FIG. 2 is a partial elevational view of the washing apparatus of FIG. 1 evidencing the motion of the washing apparatus in use.

FIGS. 3-5 are partial elevational views of a portion of the washing apparatus including the frame and mitting curtains.

FIG. 6 is a perspective view showing the planetary gear arrangement used to provide motion to the frames.

FIG. 7 is a diagram showing a top view of details of the washing apparatus.

FIG. 8 is a perspective view showing auxiliary equipment useful with the inventive washing apparatus.

FIG. 9 is a plan view looking up into the interior of a frame.

### DETAILED DESCRIPTION OF THE INVENTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

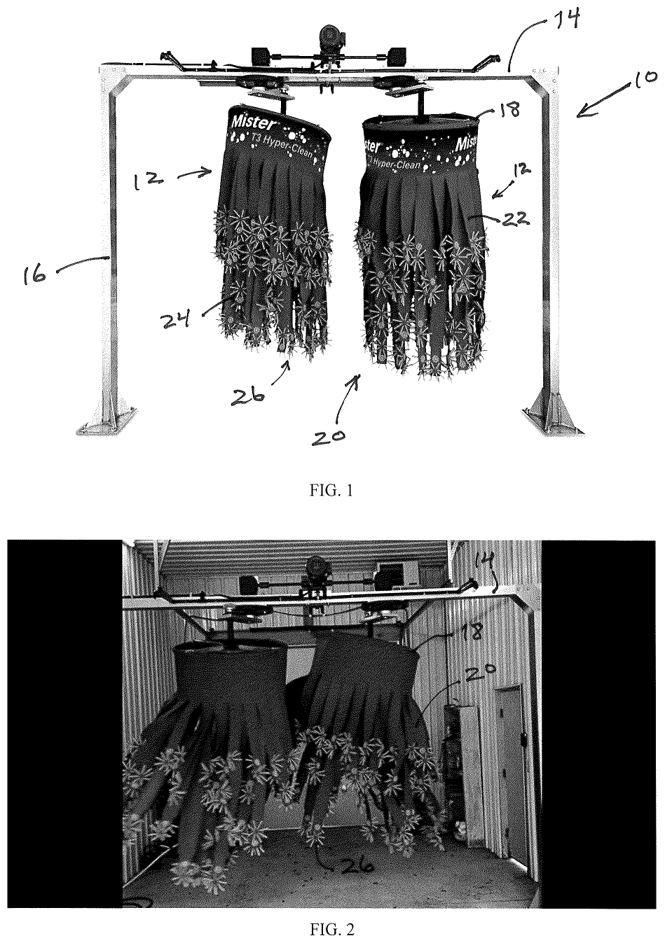

The present invention provides a washing apparatus which provides unique movement of mitting members used to wash a vehicle. The washing apparatus 10 includes one or more mitter systems 12. As shown for example in FIG. 1, the apparatus may comprise a pair of mitter systems positioned to wash particular portions of a vehicle. Shown in FIG. 1 is an apparatus comprising two mitter systems positioned to wash the full width of a vehicle front, top and back. The mitter systems are mounted to a horizontal support 14 and are movable relative thereto. Horizontal support 14 is shown being secured to vertical frame components 16, but it will be appreciated that the only requirement is that the mitter systems are supported above the surface a distance sufficient to be used to wash vehicles.

In general respects, the washing apparatus 10 includes mitter systems 12 which include a frame 18 to which a number of mitter strips are attached. In a preferred embodiment, the mitter strips 20 are arranged on frames 18 in a circular pattern. This facilitates the action of the mitter systems when rotated, although other arrangements may also be used. The mitter strips hang vertically down from the frame, and may extend to various lengths. As shown in FIG. 1, in one embodiment there are outer mitter strips 22 and inner mitter strips 24. In an embodiment, the inner mitter strips are shorter and therefore provide more vertical cleaning positions. In a particular embodiment, the mitter strips include cleaning brushes 26.

Brushes

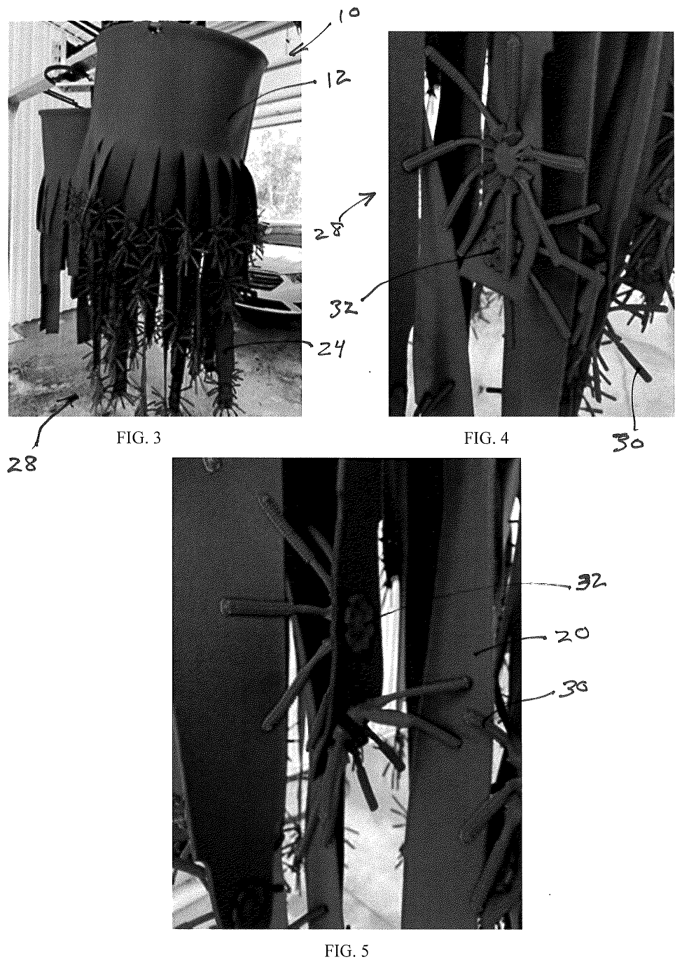

In an embodiment, the cleaning brushes comprise Squid brushes as disclosed in pending U.S. patent application Ser. No. 17/845,227, filed Jun. 21, 2022, the entirety of the disclosure of which is hereby incorporated by reference. The Squid brushes are so-named as in certain conditions they have an appearance that is suggestive of a squid. As particularly shown in FIGS. 3-5, the Squid brushes include several fingers 30 extending from a central hub 32. The mitter strips may be provided with openings which receive all of the fingers of a given brush. Alternatively, the mitter strips may include an array of openings with each opening receiving one of the fingers 30. Further, the washing apparatus is also useful with any of a variety of other brush types suitable for the indicated use.

Mitter System Drivers

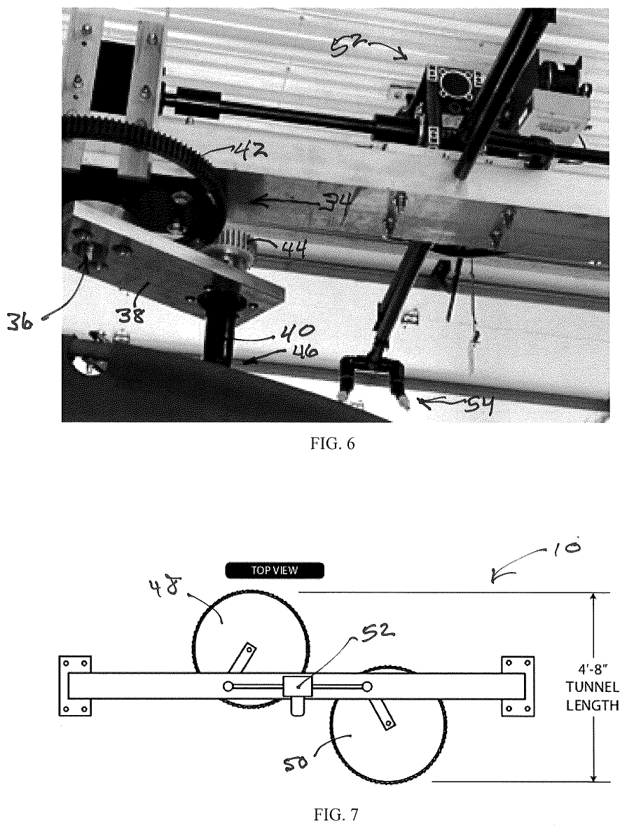

The mitter systems 12 are mounted to the horizontal support in a manner that provides unique, and highly effective, movement of the mitter strips during cleaning. In general, the washing apparatus 10 utilizes a planetary gear arrangement 34 to support and move the mitter systems. Various aspects of planetary gear arrangement 34 are shown in FIG. 6.

It is shown that washing apparatus 10 includes in one embodiment a planetary gear arrangement 34 providing unique movement of the mitter systems. The planetary gear arrangement 34 is mounted to horizontal support 14. A first axle 36 is mounted to horizontal support 14 and is rotatable about a first vertical axis. A pivot arm 38 has a first end and a second end, the first end being secured to first axle 36 to rotate with the first axle. A second axle 40 is mounted to the second end of pivot arm 38 and is rotatable about a second vertical axis.

Planetary gear arrangement 34 comprises a first gear 42 fixedly secured in a horizontal plane to horizontal support 14 and located coaxial with first axle 36. Planetary gear apparatus 34 further comprises a second gear 44 smaller than first gear 42. Second gear 44 is fixedly mounted to second axle 40, and is rotatable about the second vertical axis. First gear 42 is engaged with second gear 44 such that rotation of pivot arm 38 causes second axle 40 and second gear 44 to be rotated by first gear 42.

Frame 18 is mounted to second axle 40. Thus, the mitter system moves in two primary ways. First, the engagement of the second gear with the first gear results in a rotation of the mitter system around the second axis, which corresponds with the rotation of second axle around its axis. Second, frame 18 is mounted to the second axle, which is mounted to the second end of pivot arm 38. This results in movement of the rotation frame around the first axis.

Another manner of movement is provided by the shape of axle 40 as it extends down from the pivot arm. The lower portion 46 of axle 40 is bent at a slight angle to the rotational axis. As a result, frame 18 is continually changing its angular position. This can be seen, for example, in FIGS. 1-2. This provides both rotational and up-and-down movement to the mitter strips. It will further be appreciated that the systems can be operated in the reverse direction. This may be particularly useful for enhancing the cleaning of a vehicle as it moves relative to the mitter systems.

In an alternative embodiment, the washing apparatus comprises a mitter system which is mounted to an axle rotating about a vertical axis, without the planetary gear arrangement. Also in this embodiment, the mitter system may be mounted at a slight angle to the rotational axis of the second axle.

While a single frame and mitter system has been specifically described, it is also an aspect of the invention to provide at least a second washing apparatus which works in concert with the first washing apparatus. The first and second washing apparatus may be the same or different, but in one embodiment the two are identical as this facilitates coordinating the two systems. In addition, paired mitter systems are optimally balanced in their movement to minimize the overall forces produced by the washing apparatus. Also, the mitter systems are coordinated to account for the unique movements caused by an angled attachment of the mitter systems relative to the axis of rotation of the second axle.

Referring to FIG. 7, a washing system is shown in which a first apparatus 48 is paired with a second apparatus 50. As shown a single motor 52 can be used to operate both mitter systems. Again, this facilitates coordination of the two systems, such as for providing balance to the overall system.

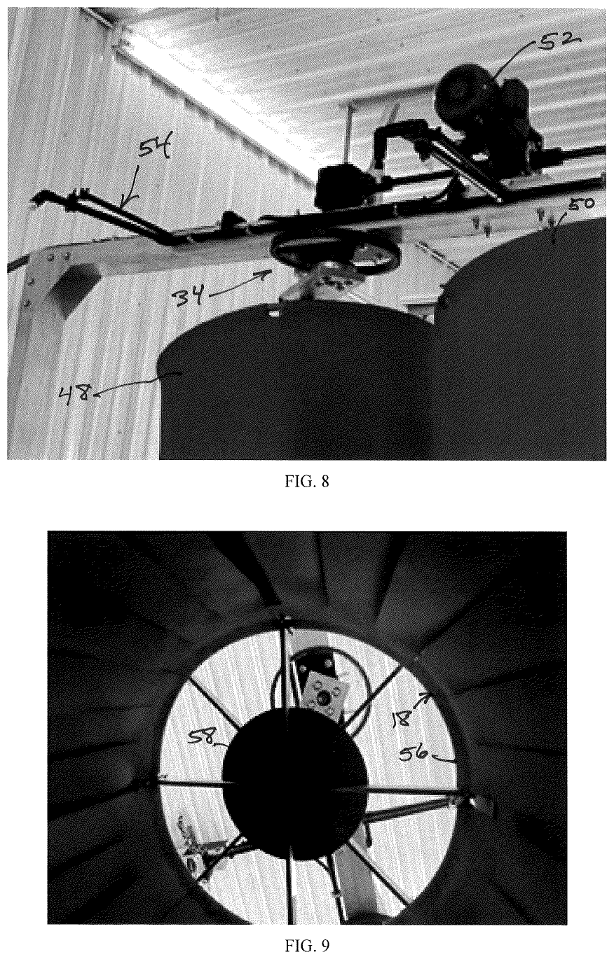

The washing apparatus may include a variety of auxiliary equipment. For example, FIG. 8 shows spray units 54.

FIG. 9 provides an upward-looking view of the interior of a frame 18 and mitter strips 20. The frame 18 is shown to have a circular rim 56 and several connectors 58 extending from the frame to a hub 58. Hub 58 mounts to the second axle 40.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

What is claimed:

1. A washing apparatus comprising:
a horizontal support;
a first axle mounted to the horizontal support and rotatable about a first vertical axis;
a pivot arm having a first end and a second end, the first end being secured to the first axle to rotate with the first axle;
a second axle mounted to the second end of the pivot arm and rotatable about a second vertical axis;
a planetary gear system comprising a first gear fixedly secured in a horizontal plane to the horizontal support located coaxial with the first axle, the planetary gear comprising a second gear smaller than the first gear, the second gear being fixedly mounted to the second axle, the second gear being rotatable about the second vertical axis,
the first and second gears being engaged such that rotation of the pivot arm causes the second axle and the second gear to be rotated by the first gear;
a frame mounted to the second axle; and
a plurality of mitting members attached to each frame and extending downwardly therefrom.

2. The washing apparatus of claim 1 in which the mitting members are mounted to the frame in a circular pattern.

3. The washing apparatus of claim 1 in which the mitter system is mounted at an acute angle to the axis of rotation of the second axle.

4. A washing system comprising:
a first washing apparatus and
a second washing apparatus, each washing apparatus be according to the washing apparatus of claim 1.

5. The washing system of claim 4 in which each of the mitter systems is mounted at an acute angle to the axis of rotation of its respective second axle.
